(19) United States
(12) Patent Application Publication
(10) Pub. No.: US 2021/0235566 A1
(43) Pub. Date: Jul. 29, 2021

(54) SYSTEM, METHOD AND DEVICES FOR IMPLEMENTING A FACTORY RESET OF A LUMINAIRE

(71) Applicant: SIGNIFY HOLDING B.V., EINDHOVEN (NL)

(72) Inventors: MARCO HAVERLAG, MIERLO (NL); LEENDERT TEUNIS ROZENDAAL, VALKENSWAARD (NL); PETER DEIXLER, ARLINGTON, MA (US)

(21) Appl. No.: 15/734,694

(22) PCT Filed: May 23, 2019
(86) PCT No.: PCT/EP2019/063367

§ 371 Date: Dec. 3, 2020

(30) Foreign Application Priority Data
Jun. 5, 2018 (EP) 18175868.1

(51) Int. Cl. H05B 47/19; H04L 12/24; G08C 17/02; G08C 23/04

(52) U.S. Cl. CPC H05B 47/19; G08C 23/04; G08C 17/02; H04L 41/0806

(57) ABSTRACT

A system for implementing a factory reset of a luminaire The system comprises a luminaire and a user device, the luminaire being configured to transmit a message for determining a factory rest code, FRC, via a first wireless communication medium. The user device is configured to: receive the message for determining the FRC via the first wireless communication medium; determine the FRC based on the received message; and transmit a command comprising the determined FRC via a second wireless communication medium. The luminaire is further configured to: receive the command comprising the determined FRC via the second wireless communication medium; and implement a factory reset of the luminaire, wherein the factory reset of the luminaire is triggered based on the determined FRC in the received command.

### TECHNICAL FIELD

The present disclosure relates to implementing a factory reset of a luminaire.

### BACKGROUND

Connected lighting refers to a system of one or more luminaires (or illumination sources) which are controlled not by (or not only by) a traditional wired, electrical on-off or dimmer circuit, but rather by using a data communications protocol via a wired or more often wireless connection, e.g. a wired or wireless network. Typically, the luminaires, or even individual lamps within a luminaire, may each be equipped with a wireless receiver or transceiver for receiving lighting control commands from a lighting control device according to a wireless networking protocol such as ZigBee, Wi-Fi or Bluetooth (and optionally also for sending status reports to the lighting control device using the wireless networking protocol). The lighting control device may take the form of a user terminal, e.g. a portable user terminal such as a smartphone, tablet, laptop or smart watch; or a static user terminal such as a desktop computer or wireless wall-panel. In such cases the lighting control commands may originate from an application running on the user terminal, either based on user inputs provided to the application by the user through a user interface of the user terminal (e.g. a touch screen or point-and-click interface), and/or based on an automatized function of the application. The user equipment may send the lighting control commands to the luminaires directly, or via an intermediate device such as a wireless router, access point or lighting bridge.

There is an ongoing trend in the professional lighting market to move more towards connected lighting systems which enable features such as, for example, (remote) scheduling, energy monitoring, sensor based lighting control and asset management. In many cases these systems are installed in existing buildings, in which case a wireless network is preferred in order to avoid having to draw cables (for lighting control) through the ceiling. Examples of such wireless network protocols which are used widely in current practice are open standards like ZigBee, Thread, BLE mesh, Wi-Fi and various proprietary network implementations built on top of the IEEE 802.15.4, 802.15.1 or 802.11 standards.

Before the networked lighting system can be used the system first has to be commissioned, which means that all the relevant wireless luminaires are connected to a single network, and when so desired added to different groups and zones, each with their own behaviour. In order to do this, the installer or commissioner must communicate with each individual luminaire and send it the appropriate commands to join the network and/or add it to these groups or zones.

This is currently implemented in two different ways. In the most basic case a controller box (or the first luminaire) is commanded to open a network which allows other luminaires to join this network. In many cases the wireless network in factory-new state will automatically start looking for an open network and then joins this network automatically (this is sometimes referred to as “auto-joining”). After this initial auto joining stage the installer can start to form groups and zones in the network e.g. by doing a blink search. During this blink search the installer gives (more or less at random) a command to one or more luminaires to identify where they are and/or that they are by blinking The installer then decides to which group or zone the luminaire(s) belong, and can decide at that point to add it to a specific group or not. The blinking could also be done by the system where the installer has to indicate where the luminaire is located on a map (e.g. on tablet) which implicitly assigns it to the relevant group(s). Alternatively the installer uses a pointing device (e.g. an IR remote control or a flashlight) which sends a signal to a sensor in the luminaire to identify which luminaire should be added to a specific group during the commissioning process.

During this process a luminaire may end up in the wrong network. For example, a luminaire may be placed in the wrong network if multiple networks are used throughout the building and several installers are working in parallel. There may also be other wireless networks (in ‘open’ state) in the building for other purposes (e.g. HVAC). For this reason most existing systems offer a method to send a ‘factory reset’ command which effectively resets the network configuration inside the luminaire and makes it possible for that luminaire to become part of a different network instead (and to retry the commissioning steps by letting the luminaire search for an open network again).

WO 2010095087 A1 relates to a control system which comprises: a controlled device controlled by a controller having receiving means for receiving command signals, and having a first, second and third storage locations for storing a personal ID or address (PID), network ID (NID), and the ID (RCID) of a remote control device, respectively; at least one user-operable remote control device, designed for transmitting command signals. A command signal comprises a target address code, a network ID code, a sender address code, and a command code. Normally, the controller only responds to control signals if target address code, network ID code, and sender address code match with the information in memory. The controller is capable of operating in a NO NETWORK mode, in which the controller responds to a reset command irrespective of target address code, the network ID code, and the sender address code.

### SUMMARY

According to a first aspect disclosed herein, there is provided a system comprising: a luminaire; and a user device, wherein the luminaire is configured to transmit, to the user device, a message for determining a factory reset code, FRC, wherein the message is transmitted via a first wireless communication medium; wherein the user device is configured to: receive, from the luminaire, the message for determining the FRC, wherein the message is received via the first wireless communication medium; determine the FRC based on the received message; and transmit, to the luminaire, a command comprising the determined FRC, wherein the command is transmitted via a second wireless communication medium; wherein the luminaire is further configured to: receive, from the user device, the command comprising the determined FRC, wherein the command is received via the second wireless communication medium; and implement a factory reset of the luminaire, wherein the factory reset of the luminaire is triggered based on the determined FRC in the received command.

Previous methods for implementing a factory reset of a luminaire are flawed in that they are unsecure and thus allow malicious users to disrupt the operation of the luminaire or system of luminaires. The present system however requires a user to be present and in close proximity to a luminaire in order to implement a factory reset. The user must be in close proximity to the luminaire to receive the message for determining the FRC and to transmit the command comprising the FRC to the luminaire. Thus the system requires a two-stage, presence-based factory reset process.

The first wireless communication medium has a first, limited physical range which is determined by the first wireless communication medium. The second wireless communication medium has a second, limited physical range which is determined by the second wireless communication technology.

In embodiments, the second wireless communication medium is different from the first wireless communication medium. Alternatively it is not excluded that the same wireless communication medium could be used for both for both the first and second wireless communication media.

In embodiments, the first wireless communication medium may be one of: (a) infrared, (b) coded light, (c) near-field communication, or (d) radio.

In embodiments, the second wireless communication medium may be one of: (a) infrared, (b) coded light, (c) near-field communication, or (d) radio.

In embodiments, the second wireless communication medium may have at least one additional physical constraint limiting the transmission of the command from the user device to the luminaire, other than just a limited range, e.g. resulting from signal propagation in air (radius). For example, the at least one additional physical constraint may comprise one of: (a) requiring a line-of-sight between the luminaire and the user device, and (b) requiring a physical contact between the luminaire and the user device. In alternative embodiments the second medium is an NFC medium and the limited range of the second medium is an NFC range.

In embodiments, the luminaire may first send a message to the user device for determining the FRC comprises a first information related to the FRC, wherein the the command transmitted from the user device to the luminaire comprises a second information determined based on the received first information related to the FRC, wherein the luminaire is configured to compare the first information and the received second information, wherein said factory reset of the luminaire is triggered based on said comparison of the first information and the second information.

In embodiments, the luminaire may be configured to: store the FRC in memory of the luminaire, and compare the stored FRC with the determined FRC in the received command, wherein said factory reset of the luminaire is triggered if the determined FRC in the received command matches the stored FRC.

In embodiments, the message transmitted from the luminaire to the user device for determining the FRC may comprise a first code based on the FRC, wherein the command transmitted from the luminaire to the user device may comprise a second code based on the FRC, wherein the luminaire may be configured to compare the first code and the second code, wherein said factory reset of the luminaire is triggered based on said comparison of the first code and the second code.

In embodiments, the message transmitted from the luminaire (104) to the user device (106) for determining the FRC may comprise the FRC. Alternatively, the message transmitted from the luminaire (104) to the user device (106) for determining the FRC may comprise a code based on the FRC. In these examples, the code may not be the FRC itself, but can be used to check the FRC. E.g. a check to determine whether it is based on the FRC or whether it can be used to look up the FRC. In some embodiments, the code may be a nonce. That is, the code may only be used once to determine the FRC of the luminaire (104). In some examples, the code may be encrypted using a key known to both the luminaire (104) and the user device (106). For example, the luminaire may send an encrypted version (e.g. a hash) of the FRC to the luminaire, for the luminaire to then decrypt and send back to the luminaire. The FRC may also be transmitted in the command, from the user device to the luminaire, in encrypted form.

In embodiments, the message transmitted from the luminaire to the user device for determining the FRC may comprise a unique identifier of the luminaire, wherein the user device is configured to apply a predetermined algorithm to the unique identifier in the received message to determine the FRC, wherein the luminaire is configured to: store the unique identifier in memory of the luminaire; apply the predetermined algorithm to the stored unique identifier to calculate the FRC; and compare the calculated FRC with the determined FRC in the received command, wherein said factory reset of the luminaire is triggered if the determined FRC in the received command matches the calculated FRC.

In embodiments, the luminaire may be configured to generate the FRC prior to storing the FRC in memory of the luminaire.

In embodiments, the luminaire may be configured to continuously transmit the message for determining the FRC.

In embodiments, the luminaire may be configured to temporarily transmit the message for determining the FRC in response to receiving a pre-determined signal for causing the luminaire to temporarily transmit the message.

In embodiments, the message transmitted from the luminaire to the user device for determining the FRC may comprise a unique identifier of the luminaire, wherein the user device is configured to: transmit, to the luminaire, a request for the unique identifier of the luminaire, wherein the request is transmitted via the first or second wireless communication medium; and determine the FRC by looking up the FRC in a database comprising the unique identifier linked to the FRC.

In embodiments, the luminaire may be configured to temporarily transmit the message for determining the FRC in response to receiving the request for the unique identifier of the luminaire.

In embodiments, the user device may be configured to store the message for determining the FRC at the user device and/or at a server.

In embodiments, the luminaire may be configured to implement a factory reset of the luminaire (104) if the command comprising the FRC is received from the user device (106) within a predetermined time period (e.g. from the transmission of the message to the luminaire).

In embodiments, the luminaire may be configured to determine a period of time of time between the transmission of the message for determining the FRC and the reception of the command comprising the FRC, wherein said factory reset of the luminaire is triggered if the determined period of time is less than the predetermined period of time. Alternatively, the predetermined time period decrements over time (e.g. the time period decrements upon transmission of the message for determining the FRC) and said factory reset of the luminaire (104) is triggered if the command comprising the FRC is received before the predetermined period of time expires (e.g. before the time period decrements to zero).

In embodiments, the system may comprise a second luminaire, wherein the user device may be configured to: receive, from the second luminaire, a second message for determining the FRC of the second luminaire, wherein the message is received via the first wireless communication medium; determine the FRC of the second luminaire based on the received second message; and transmit, to the second luminaire, a second command comprising the determined FRC of the second luminaire, wherein the second command is transmitted via the second wireless communication medium.

According to a second aspect disclosed herein, there is provided a method comprising: transmitting, from a luminaire to a user device via a first wireless communication medium, a message for determining a factory reset code, FRC; receiving, at the user device from the luminaire via the first wireless communication medium, the message for determining the FRC; determining, by the user device, the FRC based on the received message; transmitting, from the user device to the luminaire via a second wireless communication medium, a command comprising the determined FRC; receiving, at the luminaire from the user device via the second wireless communication medium, the command comprising the determined FRC; and implementing a factory reset of the luminaire, wherein the factory reset of the luminaire is triggered based on the FRC in the received command.

According to a third aspect disclosed herein, there is provided a luminaire comprising: a transmitter configured to transmit, to a user device via a first wireless communication technology, a message for determining a factory reset code, FRC; a receiver configured to receive, from the user device via a second wireless communication technology, a command comprising the FRC; and a controller configured to implement a factory reset of the luminaire, wherein the factory reset of the luminaire is triggered based on the FRC in the received command.

According to a fourth aspect disclosed herein, there is provided a user device comprising: a receiver configured to receive, from a luminaire via a first wireless communication technology, a message for determining a factory reset code, FRC; a controller configured to determine the FRC based on the received message; and a transmitter configured to transmit, to the luminaire via a second wireless communication technology, a command comprising the determined FRC.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example environment comprising a lighting system,

FIG. 2 shows schematically an example of a plurality of luminaires divided into network groups,

FIG. 3 shows schematically an example system for implementing a factory reset of a luminaire, and

FIGS. 4A-4C show schematically example timing diagrams of the described embodiments.

### DETAILED DESCRIPTION

In wireless connected lighting systems the first step after physical installation is the commissioning of the network. This places different wireless luminaires into network groups, in which the luminaires can communicate with each other and, if so desired, with a wireless gateway such as a central lighting bridge. Sometimes the commissioning process does not go as intended and the wrong luminaires end up in the network (or the wanted luminaires end up in another network). To correct this, it is possible to remove these luminaires from the existing network group by restoring them to a factory reset mode, and then re-attempting the commissioning process.

Previous methods for implementing a factory reset of a luminaire do not have any form of security built-in, which enables the possibility that malicious persons can remove luminaires from the network, disabling the correct functioning of the wireless lighting system. For example, the removal of a luminaire means that sensor-based occupancy detections from the removed luminaire no longer reach the other luminaire in the same zone or group, and hence these luminaire will no longer respond to this sensor. In addition this also works in the opposite direction; the affected luminaire will no longer receive any sensor detections from other members of the group and hence will not respond to them. In addition, global on/off or dimming commands (e.g. from a building automation environment) will not reach the application logic in the luminaire so it remains in the same (on or off) state indefinitely. For these reasons, amongst others, it is necessary this the ‘factory reset command’ or ‘factory reset code’ (FRC) cannot be communicated to the luminaire by unauthorized people (e.g. by hacking into the lighting network), and instead only given by the installer responsible for the system maintenance.

Embodiments of the present invention employ a secret key to authenticate the factory reset command, thus preventing such malicious parties disturbing the system.

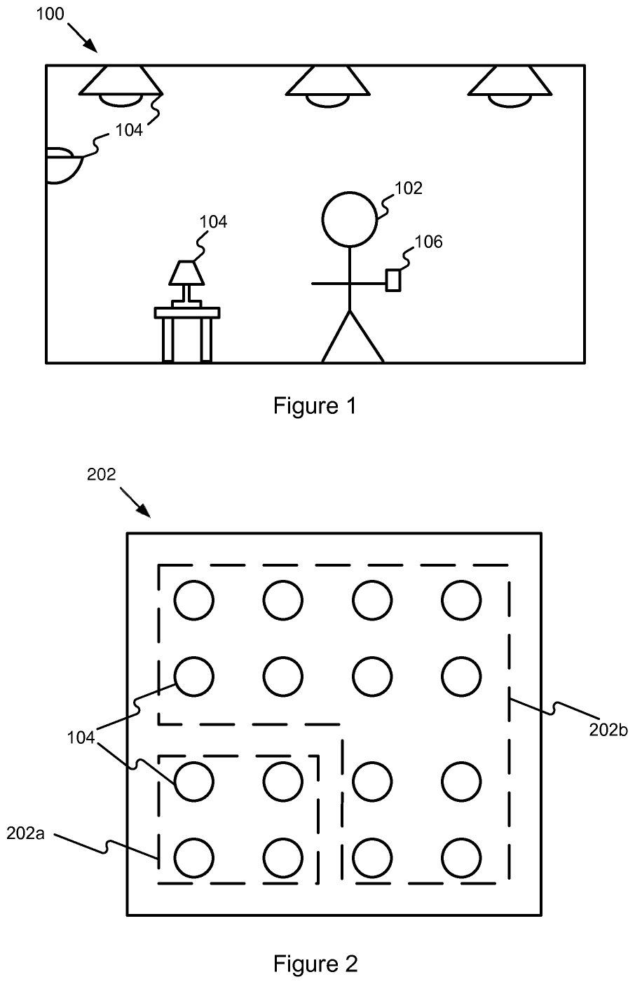

FIG. 1 illustrates an example environment 100 in which embodiments disclosed herein may be employed. The environment 100 is a space which may be occupied by one or more users 102. The environment 100 may take the form of an indoor space such as one or more rooms of a home, office or other building; an outdoor space such as a garden or park; a partially covered space such as a gazebo; or a combination of such spaces such as a campus or stadium or other public place that has both indoor and outdoor spaces.

The environment 100 is equipped with one or more luminaires 104 installed or otherwise disposed at different locations throughout the environment 100. A luminaire104 may refer to any kind of illumination device for illuminating an environment or part of the environment occupied by a user 102, whether providing, for example, ambient lighting or specific task lighting. Each of the luminaires 104 may take any of a variety of possible forms, such as a ceiling or wall mounted luminaire, a free-standing floor or table luminaire, or a less traditional form such as a luminaire embedded in a surface or an item of furniture. The different luminaires 104 in the environment 100 need not take the same form as one another. Whatever form it takes, each luminaire 104 comprises at least one lamp (illumination element) and any associated housing, socket and/or support. Examples of suitable lamps include LED-based lamps, or traditional filament bulbs or gas discharge lamps.

The environment 100 is also equipped with one or more user devices 106. For example, each zone or locality may comprise a single respective user device 106. Alternatively, each zone or locality may comprise more than one respective user device 106. The user device 106 may be, for example, a mobile device including mobile or cell phones (including so-called “smart phones”), personal digital assistants, pagers, tablet and laptop computers and wearable communication devices (including so-called “smart watches”).

As shown in FIG. 2, in some scenarios the luminaires 104 in the environment 100 may be placed into a plurality of different network groups 202. Each network group 202 may correspond to a different zone or locality within the environment, such as different rooms, each illuminated by a different respective subset of one or more of the luminaires 104. For example, a zone may correspond to e.g. a living room, kitchen, hall, and bathroom, multiple bedrooms in a home; or multiple offices, hallways, a reception and a canteen or breakroom in an office building. In other examples, a network group 202 may not correspond to any particular zone within the environment. For example, a single zone (e.g. room) may have more than one network group 202. In another example, a network group 202 may include luminaires from more than one zone. The example of FIG. 2 shows two network groups 202a, 202b each comprising a different subset of luminaires 104.

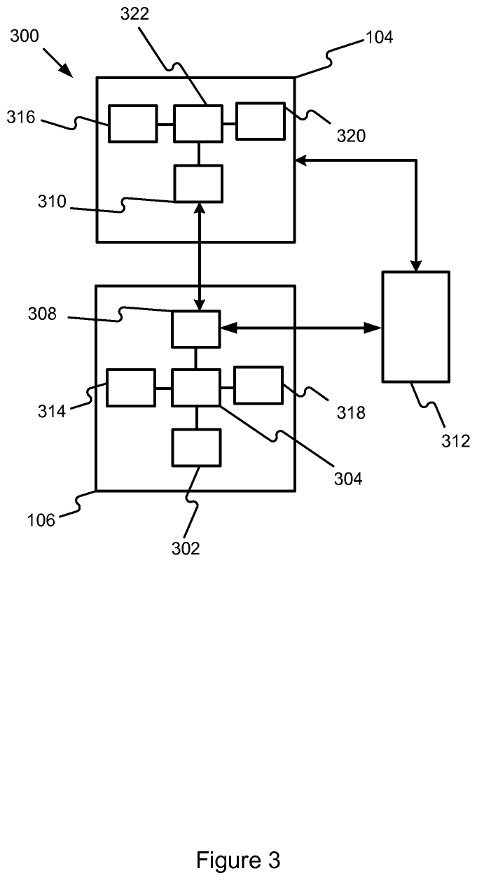

FIG. 3 illustrates an example of a system 300 for implementing a secure factory reset of a luminaire 104 through use of a user device 106. The user device 106 may optionally comprise a user interface 302 arranged to receive an input from the user and operatively coupled to a controller 304. The user interface 302 may comprise a display in the form of a screen and some arrangement for receiving inputs from the user. For example, the user interface 302 may comprise a touch screen, or a point-and-click user interface comprising a mouse, track pad, or tracker ball or the like. Alternatively or additionally, the user interface 302 may comprise a dedicated actuator or control panel for controlling the luminaires 104 within the environment. For example, the user device 106 may be in the form of a dedicated control unit (wired or wireless) which can be operated by the user, e.g. by using one or more buttons, sliders, switches and/or dials of the dedicated control panel.

The controller 304 of the user device 106 may also be coupled to the luminaire 104 discussed in relation to FIG. 1 via wireless transceivers 308, 310. The controller 304 may thereby control the luminaire 104 based on commands input by the user 102. The user device 106 and luminaire 104 may each comprise a respective wireless transmitter and receiver (or transceiver 308, 310) for communicating via any suitable wireless medium, e.g. a radio transceiver for communicating via a radio channel (though other forms are not excluded, e.g. an ultrasound or infrared transceiver). The wireless transceivers 308, 310 may comprise, for example, a ZigBee, Bluetooth, Wi-Fi, Thread, JupiterMesh, Wi-SUN, 6LoWPAN, etc. interface for communicating with the luminaire 104 or user device, respectively, and with the central bridge or server 312. For instance the radio channel may be based on the same radio access technology used by the wireless transceiver (e.g. ZigBee, Bluetooth, Wi-Fi, Thread, JupiterMesh, Wi-SUN, 6LoWPAN, etc.). The radio channel can be used by the user device 106 to control the luminaires 104.

Alternatively, the wireless transceiver 308 may communicate with the illumination sources 104 via a central bridge or a server 312, for example, over a local area network such as a WLAN or a wide area network, such as the internet. Communication may be via the wireless transceivers 308, 310. Alternatively, the luminaires 104 may each comprise a wired connection, e.g. to communicate with a central bridge 312. In some examples, the wireless transceiver 310 may communicate with other luminaires 104 via a wireless network and/or via the central lighting bridge 310, for example, over a local area network or a wide area network such as the internet. It is also not excluded that a wired connection could alternately, or additionally, be provided between the luminaires 104 themselves, or between a central lighting bridge 312 and the luminaires 104 for control purposes, e.g. an Ethernet or DMX connection.

The user device 106 also comprises a receiver 314 configured to detect a signal transmitted from a transmitter 316 of the luminaire 104. For example, the transmitter 316 may be a radio frequency identification device (RFID) tag and the receiver 314 may be an RFID reader. In one example, the transmitter 316 may be a near field communication (NFC) element and the receiver 314 may be an NFC reader. In another example, the transmitter 316 may be an optical identifier. For example, the optical identifier may be a barcode or a quick response (QR) code and the receiver 314 may be a barcode reader or a QR code reader such as a camera installed in the user device 106. In another example, the transmitter 316 and receiver 314 may be an infrared emitter and an infrared detector respectively. In yet another example, the transmitter 316 may be a lamp configured for emitting coded light messages and the receiver 314 may be a camera configured for receiving coded light messages.

Similarly, the user device 106 comprises a transmitter 318 operatively coupled to the controller 304. The transmitter 318 may be used to transmit a signal to a receiver 320 of a luminaire 104. For example, the transmitter 318 may be a radio frequency identification device (RFID) tag and the receiver 320 may be an RFID reader. In one example, the transmitter 318 may be a near field communication (NFC) element and the receiver 320 may be an NFC reader. In another example, the transmitter 318 may be an optical identifier. For example, the optical identifier may be a barcode or a quick response (QR) code and the receiver 320 may be a barcode reader or a QR code reader such as a camera installed in the user device 106. In another example, the transmitter 3120 and receiver 318 may be an infrared emitter and an infrared detector respectively. In yet another example, the transmitter 318 may be a lamp (e.g. a flashlight) configured for emitting coded light messages and the receiver 320 may be a camera configured for receiving coded light messages.

The luminaire 104 has a controller 322 operatively coupled to the transmitter 316 and to the receiver 322. The controller 322 may also be operatively coupled to the wireless transceiver 310.

The following describes a system 300 and method for improving the security of implementing a factory reset of a luminaire 104, for example, to re-commission the luminaire 104.

The system comprises at least one luminaire 104 and at least one user device. The luminaire 104 is configured to transmit a message to the user device 106 via a first wireless communication medium. The first wireless communication medium may have a limited physical range. The message allows for the determination of a factory reset code (or command) required to implement a factory reset of the luminaire 104. The transmitted message may only be transmitted across a certain distance (radius) from the transmitter and/or the transmitted message can only be received correctly within a certain distance (radius) from the transmitter. In other words, the transmitted message may only be received within a given proximity of the transmitter. Herein, wireless communication medium is synonymous with a wireless communication channel, a wireless communication modality and a wireless communication access technology.

For example, the first wireless communication medium may be infrared. That is, the luminaire 104 may have a transmitter in the form of an infrared emitter configured to transmit messages via infrared light.

In another example, the first wireless communication medium may be coded light. That is, the luminaire 104 may be configured to use its one or more light sources to transmit coded light messages. Coded light communication refers to techniques whereby information is communicated in the form of a signal embedded in the visible light emitted by a light source. Coded light is sometimes also referred to as visible light communication. Coded light communication is generally known in the art and will not be described in more detail herein.

In another example, the first wireless communication medium may be near-field communication (NFC). NFC generally refers to a set of communication protocols that enable two electronic devices to establish communication by bringing them within a certain range of each other (e.g. 4 cm). For example, the luminaire 104 may comprise an active or passive NFC tag which comprises the content of the message to be transmitted.

As another example, the first wireless communication medium may be radio. For example, the luminaire 104 may have a radio transmitter for transmitting via a radio communication technology such as, for example, Bluetooth, Bluetooth Low Energy, and ZigBee. Additionally or alternatively, the first wireless communication medium may be a radio-frequency identification (RFID) medium using RFID tags. For example, the luminaire 104 may have an active tag with an on-board battery that transmits its signal. Alternatively, the tag may be battery-assisted passive that is activated when in the presence of an RFID reader, or the tag may be passive and use the radio energy transmitted by the reader (e.g. the receiver of the user device).

The user device 106 is configured to receive the transmitted message via the first communication medium. That is, the user device 106 comprises a receiver that complements the luminaire's transmitter. For example, if the message is transmitted via infrared, coded light, NFC or radio, the user device 106 may comprise, respectively, an infrared receiver, a camera, an NFC reader or a radio receiver.

The user device 106 is configured to determine a received FRC based on the received message, i.e. based on the contents of the received message. That is, the user device 106 determines a factory reset code which may or may not be the actual factory reset code required to implement a factory reset of the luminaire 104. Several different embodiments by which the FRC may be determined are described below.

The user device 106 is also configured to transmit a command comprising the determined FRC to the luminaire 104 via a second wireless communication medium. The second wireless communication medium may have a limited physical range. The second wireless communication medium is similar to the first wireless communication medium in that the transmitted command may only be transmitted across a certain distance (radius) from the user device's transmitter and/or the transmitted command may only be received correctly within a certain distance (radius) from the transmitter. In other words, the transmitted command may only be received within a given proximity of the transmitter.

For example, the second wireless communication medium may, for example, infrared, coded light, NFC or radio. It will be appreciated that the user device 106 has a transmitter configured to transmit the command over the particular medium, with the luminaire 104 having a complementary receiver. For example, the user device 106 may have an infrared emitter for transmitting the command over infrared to an infrared receiver of the luminaire 104.

The luminaire 104 is configured to receive the command comprising the FRC determined by the user device. The user device 106 may be configured to extract the FRC from the command if necessary. The user device 106 is further configured to implement a factory reset based on the determined FRC in the command.

The system advantageously requires the commissioner to be present and in close proximity of the luminaire 104 to receive the message for determining the FRC. This message can be thought of as a challenge that must be detected in person. Furthermore, the commissioner must also be present and in close proximity of the luminaire 104 when transmitted the command to reset the luminaire 104. In other words, to determine the FRC that causes the luminaire 104 to factory reset, the person trying to reset the luminaire 104 must be in a locally constrained range of the luminaire 104 both when retrieving the message and transmitting the command.

The first wireless communication medium may be the same as the second wireless communication medium. An advantage of this is that the user device 106 and luminaire 104 require less hardware. Alternatively, the first wireless communication medium and the second wireless communication medium may be different.

In some embodiments, the second wireless communication medium may have at least one additional physical constraint limiting the transmission of the command from the user device 106 to the luminaire 104, other than just a limited range (radius). For example, the at least one additional physical constraint may comprise one of: (a) requiring a line-of-sight between the luminaire 104 and the user device, and (b) requiring a physical contact between the luminaire 104 and the user device. In alternative embodiments the second medium is an NFC medium and the limited range of the second medium is an NFC range, e.g. 4 cm. An advantage of this is that only a person being in direct contact with or being, for example, being directly underneath a luminaire 104 can transmit the command containing the reset code.

Additionally or alternatively, the first wireless communication medium may have at least one additional physical constraint limiting the transmission of the message from the luminaire 104 the user device, other than just a limited range (radius).

In some embodiments, the message transmitted from the luminaire (104) to the user device (106) comprises a first information for determining the FRC. The first information is related to the FRC of the luminaire (104). It may be the FRC itself, or a code to be used to check the FRC, such as a hash of the FRC, or more generally, an encrypted version of the FRC. The first information can also be a nonce, which may only be used once to determine the FRC of the luminaire (104), for example by encrypting the nonce with a secret, cryptographic, algorithm. Another alternative is that the first information is a unique identifier for the user device (106) to determine the FRC of the luminaire (104).

The user device (106) then determines a second information based on the received message from the luminaire (104) comprising the first information, and sends back to to the luminaire (104) a command comprising the second information.

By receiving the command from the user device (106), the luminaire (104) is configured to compare the first information and the received second information, and said factory reset of the luminaire (104) is triggered based on the comparison of the first information and the second information.

In a first embodiment, the message transmitted from the luminaire 104 to the user device 106 for determining the FRC may contain the FRC required to reset the luminaire 104. That is, the user device 106 is provided with the factory reset code. Here, the user device 106 determines the FRC by extracting the FRC from the message. The message may be the FRC itself and not contain any other information. An advantage of this is that the user device 106 must be present in the environment to receive the FRC.

Alternatively, the message transmitted from the luminaire 104 to the user device 106 may not contain the FRC itself Instead, the luminaire 104 may transmit a first code based on the FRC to the user device 106. In these examples, the code may not be the FRC itself, but it can be used to check the FRC. For example, the code may be a hash of the FRC, or more generally, an encrypted version of the FRC. The FRC may be encrypted by the luminaire 104 and decrypted by the user device 106 using a shared key or algorithm (e.g. a shared hash function). The code may be used to look up the FRC, e.g. in a look-up table or database stored at the user device and/or the server. The user device 106 may transmit a second code based on the FRC to the luminaire 104. For example, the FRC may also be transmitted in the command, from the user device to the luminaire, in encrypted form. The command may include a cryptographic hash of the FRC. Such a hash would be sufficient to verify that the user device has the FRC (without actually releasing the FRC in plain text). In some embodiments, the code may be a nonce. That is, the code may only be used once to determine the FRC of the luminaire 104. For example, once the luminaire 104 has been reset using the code, the same code may not be usable to reset the luminaire again).

The luminaire may compare the first code and the second code to determine whether the factory reset should be implemented. For example, if the second code is determined to be a hash of the FRC (first code), the factory reset is triggered since the luminaire can verify that the user device must have the FRC.

After the user device 106 transmits the FRC in the command to the luminaire 104, the luminaire 104 compares the FRC in the received command with the FRC transmitted in the message to the user device. If the comparison results in a match, a factory reset of the luminaire 104 is triggered. If the comparison does not result in a match, a factory reset of the luminaire 104 is not triggered. Here, an identical match may be required. Alternatively, if the FRC in the message and the FRC in the command match are sufficiently similar, the FRC may be triggered. This may account for distortion of the message, e.g. introduced across coded light communication.

The luminaire 104 may generate the FRC that is subsequently transmitted in the message to the user device. An advantage of this is that the FRC may change over time. For example, the luminaire 104 may generate the FRC during commissioning of the luminaire 104. Alternatively, the FRC may be transmitted to the luminaire 104, e.g. from the manufacturer, or from a server. The luminaire 104 may store the FRC in memory (e.g. local storage) of the luminaire 104. Alternatively, the FRC may be stored at a server (e.g. in the cloud).

The user device 106 may store the FRC in the received message in local storage of the user device 106 and/or at a server (e.g. in the cloud). For example, the user device 106 may receive the message for determining the FRC and store the message (i.e. the FRC) for later use. When there is a requirement to reset the luminaire 104, the FRC is retrieved from the local storage and/or server and transmitted to the luminaire 104 in the command.

In a second embodiment, the message transmitted from the luminaire 104 to the user device 106 for determining the FRC contains a unique identifier of the luminaire 104. For example, the unique identifier may be a number unique to a particular luminaire 104. The unique identifier may be assigned to the luminaire 104 by the manufacturer. The unique identifier may be, for example, a media access control (MAC) address, a random number, or a hash thereof. The unique identifier may be unique to a particular luminaire 104 within the environment, or within a subset of luminaires 104 in the environment. An advantage of this is that the FRC is that both the user device 106 must have access to both the unique identifier and the predetermined algorithm to reset the luminaire 104.

Instead of transmitting an FRC to the user device, the user device 106 is provided only with the unique identifier for determining the FRC. The user device 106 may determine (or generate) the FRC by applying a predetermined algorithm to the unique identifier. For example, the predetermined (fixed) algorithm may be a hash function. The predetermined algorithm may be a mathematical function that takes an input (i.e. the unique identifier) of arbitrary size and outputs a fixed size value (i.e. an FRC).

After the user device 106 generates the FRC by applying the predetermined algorithm to the unique identifier, the user device 106 transmits the generated FRC in the command to the luminaire. The luminaire 104 also applies the same predetermined algorithm to the unique identifier transmitted to the user device 106 to generate the FRC. The luminaire 104 may generate the FRC before or after transmitting the message to the FRC. For example, transmitting the message for determining the FRC to the user device 106 may trigger the luminaire 104 to generate the FRC. The generated FRC may be stored locally at the luminaire. The luminaire 104 compares the FRC in the received command with the FRC generated by the luminaire. If the comparison results in a match, a factory reset of the luminaire 104 is triggered. If the comparison does not result in a match, a factory reset of the luminaire 104 is not triggered. Here, an identical match may be required.

The user device 106 may store the generated FRC in local storage of the user device 106 and/or at a server (e.g. in the cloud), e.g. for later use. When there is a requirement to reset the luminaire, the generated FRC is retrieved from the local storage and/or server and transmitted to the luminaire 104 in the command.

In some examples, the predetermined algorithm is shared between the luminaire 104 and the user device. For example, the luminaire 104 may transmit the predetermined algorithm to the user device. The predetermined algorithm may be transmitted in the same message as the unique identifier. Alternatively, a separate message containing the predetermined algorithm may be sent prior to and/or subsequent to the message for determining the FRC.

In other examples, the user device 106 and luminaire 104 may be provided with the predetermined algorithm, e.g. during manufacture. The predetermined algorithm may be transmitted to (or downloaded from) a server. For example, the user device 106 and/or luminaire 104 may request the predetermined algorithm from the server.

In either of the first and second embodiments, the luminaire 104 may continuously transmit the message for determining the FRC. For example, the luminaire 104 may transmit the message in coded light, with the message repeating on a loop. This may allow the user device 106 to receive the message whenever a factory reset of the luminaire 104 is required.

Alternatively, the luminaire 104 may transmit the message for a predetermined period of time. The message may be transmitted, for example, in response to a trigger received from the user device. The trigger may be, for example, a message transmitted across a radio connection, or one or more flashes of (infrared or visible) light received by a light sensor at the luminaire. That is, the user device 106 may probe the luminaire 104 which causes the luminaire 104 to transmit the message for a time period of, for example, ten seconds. The time period may be user configurable.

In a third embodiment, the message transmitted from the luminaire 104 to the user device 106 for determining the FRC may contain the unique identifier of the luminaire. The unique identifier is associated with a FRC for the luminaire, both of which are stored in a database. For example, the database may be stored at a server (e.g. in the cloud), or locally at the device.

In this embodiment, the user device 106 first transmits a request to the luminaire 104 for the unique identifier via the first or second wireless communication medium. For example, the request may be transmitted via infrared. In response, the luminaire 104 transmits the message (containing the unique identifier) for determining the FRC. The message may be temporality transmitted for a predetermined period of time. Alternatively, the message may be transmitted until the luminaire 104 receives a command from the user device.

The user device 106 uses the unique identifier to look up (e.g. search or identify) the FRC linked to the unique identifier in the database. The user device 106 retrieves the FRC and transmits the retrieved FRC in the command to the luminaire. The luminaire, having stored the FRC associated with the unique identifier (e.g. stored locally or retrieved from a server) compares the FRC in the command with the stored FRC and implements a factory reset if they match.

As an optional feature, the luminaire 104 may be configured to implement a factory reset of the luminaire 104 only if the command comprising the FRC is received from the user device 106 within a predetermined time period. For example, the time period may begin upon transmission of the message from the luminaire 104 to the user device 106.

The predetermined time period may decrement over time (e.g. the time period decrements upon transmission of the message for determining the FRC) and said factory reset of the luminaire (104) is triggered if the command comprising the FRC is received before the predetermined period of time expires (e.g. before the time period decrements to zero). If the time period (e.g. a timer or counter) reaches zero before the command comprising the FRC is received, the luminaire 104 may effectively ignore the command and not implement the factory reset. For example, the predetermined time period may be one minute, sixty counts, etc. Transmission of the message will trigger the timer or counter to decrease, e.g. by one second or one count at a time.

As another example, the luminaire 104 may determine a time period between the transmission of the message, to the user device, for determining the FRC and the reception of the command, from the user device, comprising the FRC. The luminaire 104 may, in some examples, only implement a factory reset of the command if the time period is less than the predetermined period of time. In this example, the predetermined period of time is a fixed time period that does not decrease. For example, the luminaire 104 may effectively ignore the command, even if it contains the correct FRC, if the command is received more than a set amount of time (e.g. several minutes, one hour, one day) after the luminaire 104 first transmits the message to the user device. An advantage of this is that, for increased security, the user device 106 only has a limited amount of time to trigger the reset.

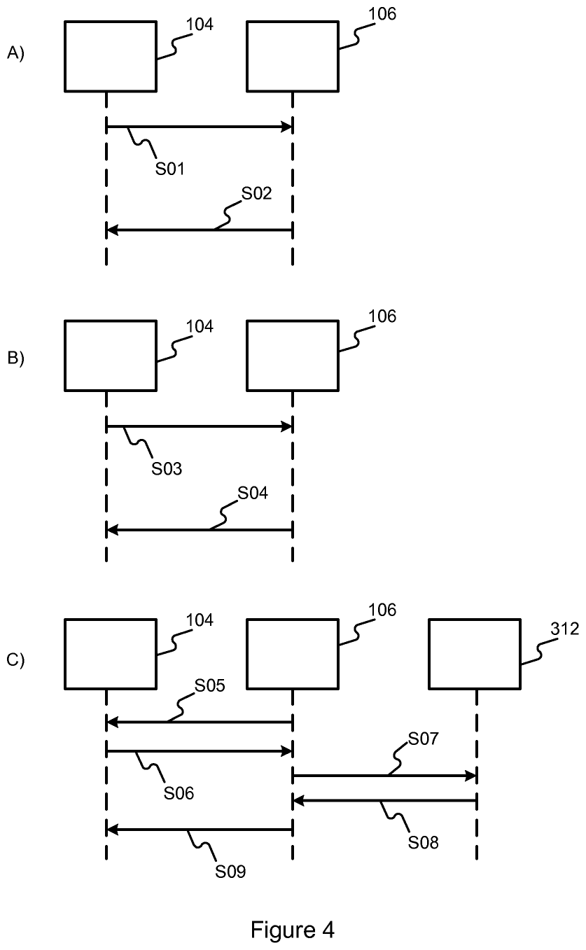

FIGS. 4A, 4B and 4C illustrate examples of the first, second and third embodiments respectively. In the examples of FIGS. 4A-4C, time flows from top to bottom of the page along the dashed lines.

In the example shown in FIG. 4A, at S01 a factory reset code (FRC) is sent out as a coded-light message by the luminaire 104 (either continuously, or after some initial trigger from the user device 106 for a period of time) and detected with the receiver (e.g. a camera) of the user device. Here, the user device 106 may be a smartphone. The received FRC may be stored locally or in the cloud for later usage. The unique factory reset code may be generated by the luminaire 104 during commissioning and stored locally on the node. Alternatively, it could be sent over a mesh network to the user device, possibly via the cloud.

When there is a need to reset a luminaire, this factory reset key may be retrieved from memory of the user device 106 (e.g. via an app) or from cloud storage and sent at S02 as an infrared command to the luminaire. Upon reception of the command, the luminaire 104 compares the factory reset key with the one that it has stored. If the two codes are the same, the factory reset is implemented. This procedure authenticates that the person that sends the factory reset code is standing under the fixture (due to IR usage). As a variation on this, the factory reset code could also be made time-dependent, with a configurable expiration time. Moreover the code could be sent in the message with a project-specific encryption code for additional security.

In the example shown in FIG. 4B, at S03 a unique identifier (or number) is sent out from the luminaire 104 as a coded-light message (either continuously, or after some initial trigger from the user device 106 for a period of time) and detected with the camera of the user device. The unique number may be generated for the luminaire 104 and stored locally on the node.

From this unique number a factory reset code is calculated using a predetermined (e.g. fixed) algorithm. At S04, this factory reset code is sent as an infrared command to the luminaire 104 and upon reception the luminaire 104 compares the factory reset code with the one that it calculates itself using the same fixed algorithm. If the two codes are the same the factory reset is implemented.

In the example shown in FIG. 4C, prior to installation a (random) factory reset code is programmed in the luminaire 104 (e.g. in the factory) and this code is stored at a server along with a unique identifier of the node (e.g. a MAC address). At S05 the user device 106 transmits an infrared probe (or request) to the luminaire. In response, at S06 the luminaire 104 temporarily emits its unique identifier as a coded-light message. This message is received by the user device 106 and the unique identifier is retrieved from the coded-light message. At S07 and S08, the user device 106 looks up and retrieves the factory reset code that belongs to this luminaire. Then, at S09, the user device 106 sends a second infrared message (the command) using the factory reset code to authenticate and initiate the factory reset of the luminaire.

As possible variations to the examples of FIGS. 4A-4C, the coded light message transmitted from the luminaire 104 can be given either by a coded infrared message, for example, using one of the existing infrared protocols that are known for remote control devices (e.g. RC5, RC6, NEC, . . . ), and received by a suitable infrared receiver in the user device. Similarly, the infrared messages (the command and where applicable the probe) can be sent from the user device 106 to the luminaire 104 by a coded infrared message instead of via coded light. For example, the coded light message may be sent by the torch or flash of a smartphone, or by a similar light emitting device linked to the user device. The luminaire 104 may have a light sensor configured to receive the light pattern. Other out-of-band communication methods that can be used include near-field-communication, for example, in the 13.56 MHz frequency band (NFC) or in the 840-960 MHz band (U-code).

As a further variation to the examples of FIGS. 4A-4C, if the system supports an unsecure radio connection between the user device 106 and the luminaire, e.g. an unsecure Bluetooth Low Energy (BLE) link, the information that was exposed in coded light may instead be emitted as part of a BLE beacon or in a BLE connection. In order to select the correct luminaire 104 for factory reset, the luminaire 104 may only expose its beacon after receiving an infrared (or equivalent) command. As another example, the luminaire 104 may change the contents, transmit power, or transmit frequency of an already active beacon so that the user device 106 can identify the right luminaire.

In some embodiments, the system comprises one or more additional luminaires. For example, the system may comprise a second luminaire. The second luminaire 104 is configured to perform the same actions as the first luminaire. The user device 106 may receive a message, from the second luminaire, for determining the FRC of the second luminaire. The message may be received via the first wireless communication medium, e.g. coded light. The user device 106 may determine the FRC of the second luminaire 104 based on the received second message. For example, the second message may contain the FRC itself (as in the example of FIG. 4A, first embodiment). Alternatively, the second message may contain a unique identifier of the second luminaire 104 (as in the example of FIGS. 4B and 4C, second and third embodiments). The user device 106 may then transmit a command to the second luminaire 104 that contains the determined FRC of the second luminaire. The second command may be transmitted via the second wireless communication medium, e.g. infrared.

The first and second FRC may be identical. That is, more than one luminaire 104 may be reset by the same factory reset code. This may allow more than one luminaire 104 to be reset by the user device 106 at the same. For example, if the user device 106 receives the FRC from the first luminaire, it may not have to receive a message from the second luminaire 104 in order to reset the second luminaire. An advantage of this is that the luminaires of, for example, a network group can be reset all at once. Alternatively, each luminaire 104 may have a unique factory reset code that only causes a factory reset of that respective luminaire.

The controller 304 is configured to perform the actions of the user device 106 described below and elsewhere herein. For example, the controller 304 is configured to receive the user commands via the user interface 302. The controller 304 is also configured to communicate with the one or more luminaires 104 within the environment 100 via the wireless transceiver 308 as detailed above. The controller 304 is also configured to communicate with the central bridge or server 312 via the wireless transceiver 308 as detailed below. The controller 304 is also configured to cause the transmission of commands to the luminaire 104. The controller 304 is also configured to process the received messages, e.g. to extract the FRC.

Likewise, the controller 322 is configured to perform the equivalent operations of the luminaire 104.

In embodiments the controller 304 is implemented in the form of software stored in memory and arranged for execution on a processor (the memory on which the software is stored comprising one or more memory units employing one or more storage media, e.g. EEPROM (electrically erasable programmable read-only memory) or a magnetic drive, and the processor on which the software is run comprising one or more processing units). Alternatively, some or all of the controller 304 could be implemented in dedicated hardware circuitry, or configurable or reconfigurable hardware circuitry such as an ASIC (application-specific integrated circuit) or a PGA (programmable gain amplifier) or FPGA (field-programmable gate array). Whatever form it takes, in embodiments the controller 304 may be implemented internally in a single user device 106 along with the user interface 302 and the wireless transceiver 308, i.e. in the same housing. Alternatively the controller 304 could, partially or wholly, be implemented externally such as on a lighting bridge or a server 312 comprising one or more server units at one or more geographic sites. Alternatively, the controller 304 may be partially or wholly implemented across one or more user devices 106. Where required, suitable remote communication and/or distributed processing techniques will, in themselves, be familiar to a person skilled in the art.

The luminaire 104 comprises the controller 322 operatively coupled to the transmitter 316 and receiver 320 of the luminaire for controlling and communicating with the transmitter 316 and receiver 320. In embodiments the controller 322 is implemented in the form of software stored in memory and arranged for execution on a processor (the memory on which the software is stored comprising one or more memory units employing one or more storage media, e.g. EEPROM (electrically erasable programmable read-only memory) or a magnetic drive, and the processor on which the software is run comprising one or more processing units). Alternatively, some or all of the controller 322 could be implemented in dedicated hardware circuitry, or configurable or reconfigurable hardware circuitry such as an ASIC (application-specific integrated circuit) or a PGA (programmable gain amplifier) or FPGA (field-programmable gate array). Whatever form it takes, in embodiments the controller 322 may be implemented internally in a single luminaire 104 along with the wireless transceiver 310, transmitter 316 and receiver 320, i.e. in the same housing. Alternatively the controller 322 could, partially or wholly, be implemented externally such as on a lighting bridge or a server 312 comprising one or more server units at one or more geographic sites. Alternatively, the controller 322 may be partially or wholly implemented across one or more luminaires 104.

In embodiments the functionality of the central bridge/server 312 is implemented in the form of software stored in memory and arranged for execution on a processor (the memory on which the software is stored comprising one or more memory units employing one or more storage media, e.g. EEPROM or a magnetic drive, and the processor on which the software is run comprising one or more processing units). Alternatively it is not excluded that some or all of the functionality of the central bridge/server 312 could be implemented in dedicated hardware circuitry, or configurable or reconfigurable hardware circuitry such as an ASIC or a PGA or FPGA. Also note again that the central bridge or server 312 may be implemented locally within the environment 100 or at a remote location, and may comprise one or more physical units at one or more geographic sites.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A system for implementing a factory reset of a luminaire, the system comprising:
the luminaire; and
a user device,
wherein the luminaire is configured to transmit, to the user device, a message for determining a determined factory reset code, FRC, wherein the message is transmitted via a first wireless communication medium;
wherein the user device is configured to:
receive, from the luminaire, the message for determining the determined FRC, wherein the message is received via the first wireless communication medium;
determine the determined FRC based on the received message; and
transmit, to the luminaire, a command comprising the determined FRC, wherein the command is transmitted via a second wireless communication medium; and
wherein the luminaire is further configured to:
receive, from the user device, the command comprising the determined FRC, wherein the command is received via the second wireless communication medium; and
implement a factory reset of the luminaire, wherein the factory reset of the luminaire is triggered based on the determined FRC in the received command and wherein
the second communication medium is a radio based communication medium,
the message transmitted from the luminaire to the user device for determining the FRC comprises a unique identifier of the luminaire,
the system characterised in that:
the first wireless communication medium is one of: a) infrared, b) coded light, or c) near-field communication and
the user device is configured to:
apply a predetermined algorithm to the unique identifier in the received message to determine the determined FRC and
the luminaire is configured to:
store the unique identifier in memory of the luminaire;
apply the predetermined algorithm to the stored unique identifier to calculate a calculated FRC; and
compare the calculated FRC with the determined FRC in the received command, and wherein said factory reset, of the luminaire is triggered if the determined FRC in the received command matches the calculated FRC.

2. (canceled)

3. (canceled)

4. (canceled)

5. (canceled)

6. (canceled)

7. A system according to claim 1, wherein the luminaire is configured to generate the calculated FRC prior to storing the calculated FRC in memory of the luminaire.

8. A system according to claim 1, wherein the luminaire is configured to continuously transmit the message for determining the determined FRC.

9. A system according to claim 1, wherein the luminaire is configured to temporarily transmit the message for determining the determined FRC in response to receiving a pre-determined signal for causing the luminaire to temporarily transmit the message.

10. (canceled)

11. A system according to claim 1, wherein the user device is configured to store the message for determining the FRC at the user device and/or at a server.

12. A system according to claim 1, wherein the luminaire is configured to implement a factory reset of the luminaire if the command comprising the determined FRC is received from the user device within a predetermined time period.

13. A system according to claim 1, wherein the system comprises a second luminaire, wherein the user device is configured to:
receive, from the second luminaire, a second message for determining the FRC of the second luminaire, wherein the message is received via the first wireless communication medium;
determine the FRC of the second luminaire based on the received second message; and
transmit, to the second luminaire, a second command comprising the determined FRC of the second luminaire, wherein the second command is transmitted via the second wireless communication medium.

14. (canceled)

15. A luminaire comprising:
a transmitter configured to transmit, to a user device via a first wireless communication technology, a message for determining a factory reset code, FRC;
a receiver configured to receive, from the user device via a second wireless communication technology, a command comprising the determined FRC, determined based on the message; and
a controller configured to implement a factory reset of the luminaire, wherein the factory reset of the luminaire is triggered based on the determined FRC in the received command
wherein
the second communication medium is a radio based communication medium and
the message transmitted from the luminaire to the user device for determining the determined FRC comprises a unique identifier of the luminaire,
the luminaire characterized in that:
the first wireless communication medium is one of: a) infrared, b) coded light, or c) near-field communication and
the luminaire is configured to:
store the unique identifier in memory of the luminaire;
apply the predetermined algorithm to the stored unique identifier to calculate a calculated FRC; and
compare the calculated FRC with the determined FRC in the received command, and wherein said factory reset of the luminaire is triggered if the determined FRC in the received command matches the calculated FRC.

16. A user device comprising:
a receiver configured to receive, from a luminaire via a first wireless communication technology, a message for determining a determined factory reset code, FRC;
a controller configured to determine the determined FRC based on the received message; and
a transmitter configured to transmit, to the luminaire via a second wireless communication technology, a command comprising the determined FRC wherein
the second communication medium is a radio based communication medium and
the message transmitted from the luminaire to the user device for determining the FRC comprises a unique identifier of the luminaire,
the user device characterised in that:
the first wireless communication medium is one of: a) infrared, b) coded light, or c) near-field communication and
the user device is configured to:
apply a predetermined algorithm to the unique identifier in the received message to determine the determined FRC.

17. The luminaire according to claim 15, configured to calculate the calculated FRC prior to storing the calculated FRC in memory of the luminaire.

18. The luminaire according to claim 15, wherein the luminaire is configured to continuously transmit the message for determining the determined FRC.

19. The luminaire according to claim 15, wherein the luminaire is configured to temporarily transmit the message for determining the determined FRC in response to receiving a pre-determined signal for causing the luminaire to temporarily transmit the message.

20. The luminaire according to claim 15, wherein the luminaire is configured to implement a factory reset of the luminaire if the command comprising the determined FRC is received from the user device within a predetermined time period.
